(19) United States
(12) Patent Application Publication
(10) Pub. No.: US 2012/0048972 A1
(43) Pub. Date: Mar. 1, 2012

(54) DOUBLE TUBING DISTRIBUTING OF FERTILIZERS AND PESTICIDES FIXED TO AERIAL STRUCTURE OF CENTRAL PIVOT, THROWN AND CONTROLLED BY AUTOMATION DEVICES CONSIST OF GATE VALVES, PRESSURE VALVES, SOLENOID VALVES AND CHECK VALVES

(75) Inventor: FRANCISCO GANZER NETO, Setor Oeste.Goiania-GO (BR)

(73) Assignee: RUTH ROSA DE PAULA GANZER, Setor Oeste.Goiania-GO (BR)

(21) Appl. No.: 12/868,907

(22) Filed: Aug. 26, 2010

(51) Int. Cl. A01C 23/04

(52) U.S. Cl. 239/728

(57) ABSTRACT

“Double tubing distributing of fertilizers and pesticides fixed to aerial structure of central pivot, thrown and controlled by automation devices consist of gate valves, pressure valves, solenoid valves and check valves”, refers to a device to be installed in a central pivot (P), comprehended by a main tubing (1), due supported and fixed by staples to aerial structure (14) of central pivot, responsible by derivation and conduction of the solution to the final ending of the pivot, presenting derivations of the solution in the “T” (25) of the main tubing (1) with the towers (15) to assist the automation device (S) comprehended by gate valves (4), pressure valves (5), solenoid valves (6) and check valves (7), from where flexible hoses (13) derive to secondary tubing (2) of distribution, with adjustable heights in each segment through steel cables like suspension strings (10) and steel cables masters (11) activated by a winch turnpike (16), or by remote control, that pulverize the solution through the sprays nozzles (3), with anti-dripping valves (26), equally spaced, and the secondary tubing (2) receives the solution by the two endings, where gate valves (4), line filters (12) and sucker valves (17) were installed, being a main pumping (18) responsible by supplying of the equipment with the solution prepared in the tanks (19), passing by a device with pressure valve (20), another device of central filtering, self-cleaning filters (21), being the reservoir tanks (19) fueled of water from the main pipeline (22) pumped by an auxiliary motor-pump (24) installed with the water source (river or dam).

### BACKGROUND OF THE INVENTION

This patent of invention report deals with a new “Double tubing distributing of fertilizers and pesticides fixed to aerial structure of central pivot, thrown and controlled by automation devices consist of gate valves, pressure valves, solenoid valves and check valves”, a device to be coupled to the aerial structure of central pivot, facilitating and optimizing the distribution of fertilizers and pesticides, whose handling minimizes accidents like poisoning resulting from the nature of field work.

The difficulty that irrigators find in the application of agrochemical products through traditional equipments in the irrigated crops by equipments of Central Pivot is causing large economic losses due to low technology and operation of existed equipments.

A more recent agrochemical distribution device is being used through injection of the solution via water flow of Central Pivot. This device presents disadvantages and losses due the low efficiency in the combat and control of insects and weeds, caused by mixture of chemical products with a larger volume of water used in Pivots, besides causing the destruction of the protective layer of zinc in the internal part of the aerial tubing of the equipments, thus compromising the life cycle of them.

The success of the control of pests and diseases related to crops in general depends on the choice of the product and its correct distribution. In this sense, the chemical products are pulverized over the ground or over the plants in a uniform way, in other words, the used equipment must distribute the quantity of chemical product correctly by the area.

Basically, central pivot consists of sprinkles fixed to a structured aerial tubing divided into modules, supported by towers set on axis with motorized wheels that, by electric devices, make the central pivot equipment moves in a circular way in ground or linear to a duct.

The estate of the art anticipates some patent documents related to equipments such the above mentioned. PI 9200808-9 is based on the fabrication of a feeding duct, level in the central axis of the area to be irrigated, which will remain always supplied with water. A central tower with a motor-bomb set mounted on the base of two axis with wheels moves from an end to another of the duct, removing the water by a suction pipe with filter, which removes the water and feeds the aerial tubing, irrigating the area. The displacement of the movable pivot provides an extra gain of irrigated area. The format of the irrigated area resembles a “human kidney”.

PI 9704152-1 “System of irrigation with Central Pivot thrown by Motors of Low Power” comprises a system of irrigation through central pivot, which works with water pumps activated by motors of middle and low power, using PVC tubing and a reservoir provided at a level close to the capture, in the irrigation area. Thus the system will allow connections in the farmer extension, since the low request doesn't demand radical changes, neither the adequacy of the power line.

The low pressure in the pumps allows the use of PVC tubing, decreasing the cost of implementation and makes it accessible to the investment capacity of many farmers.

### SUMMARY OF THE INVENTION

Aware of the state of the art, its gaps and limitations, the inventor, a person skilled in the art, after observations, studies and research, created a “Double tubing distributing of fertilizers and pesticides fixed to aerial structure of central pivot, thrown and controlled by automation devices consist of gate valves, pressure valves, solenoid valves and check valves”, which consists of two tubing installed in parallel and of the same lengths of the central pivot; the superior main tubing is supported and fixed by staples in the aerial structure of the central pivot responsible by the derivation of the solution through “T” to the automation devices with the towers and still makes the conduct of the solution until the ending of the pivot. Another tubing, the second movable, which is fixed by steel cables like suspension strings with “spray” nozzles, is responsible for distribution and application of the fertilizers and pesticides products.

An automation device was installed in the main tubing of the equipment next to the motorized towers of the central pivot, mounted with several compounds of great importance to the operation of the equipment. Said device comprises gate valves, pressure valves, solenoid valves and for two check valves, mounted horizontally. The horizontally setting up of the solenoid valves favors the operation of the internal piston of said valves, which works vertically.

The operation of the valves of the automation device occurs of the following way: the gate valve has the function of interrupting the solution flow to provide an eventual system maintenance; the pressure valve is used to regulate the pressure of the sprays; the solenoid valve (electric) was linked by electric cables to the contacting key or micro-switch of the electric box present in the top of each motorized tower of the central pivot, which has the function to release or stop the flow of solution when the towers are activated, or not, showing the synchronism in the opening of the sprays during the self-pulsating pulverization and/or intermittent pulverization; the check valves interrupt the flow for tubing with sprays, installed in the posterior position still without movement, thus avoiding the overlap of the chemical product. In the movable secondary tubing, sprays with anti-dripping valves were installed in pre-determined distances, with diameter of nozzles equal to or varying with the flow determined by the position of the area of the circular crown pulverized of them. Connectors with several components were installed at each ending of the movable tubing; they were installed in one ending: the hose connector; the gate valve and the strip; in another ending, components like hose connector, gate valve, strip, derivation with gate valve for cleaning of the tubing and a sucker for the elimination of air were installed.

The adjustment of the distributing tubing height was made individually for each segment, being manual through winch turnpike, installed in the legs of each tower or in the axis of the wheels or even electrically with remote control.

In the central base of the Pivot, they were installed tanks for preparation of the chemical solution that receives the water removed of the central pivot pipeline, originated from a pumping of an auxiliary pump installed in a water source (river or dam). From the tanks, the chemical solution is pumped by a main pump to the equipment, passing by a device with a pressure valve for controlling of the pressure excess, then said pressure valve will operate in slope condition, still having another central filtering device with self-cleaning filters.

### DESCRIPTION OF DRAWINGS AND PREFERRED EMBODIMENT

To follow, the invention is explained with reference to the attached drawings, in which are represented in a illustrative and not limitative way:

FIG. 1 shows a segment of double tubing, being a main tubing (1) and a secondary tubing (2), this is the tubing of distribution of fertilizers and pesticides; the sum of the segments are equal to the length of pivot. The equipment comprises: main tubing (1); secondary tubing (2) of distribution with sprays (3); automation device with gate valves (4), pressure valves (5), solenoid valves (electric) (6) and check valves (7); flexible joints with clamps (8); reels (9); steel cables like suspension strings (10); steel cables masters (11); line filters (12) and flexible hoses (13) connecting pipes to each other.

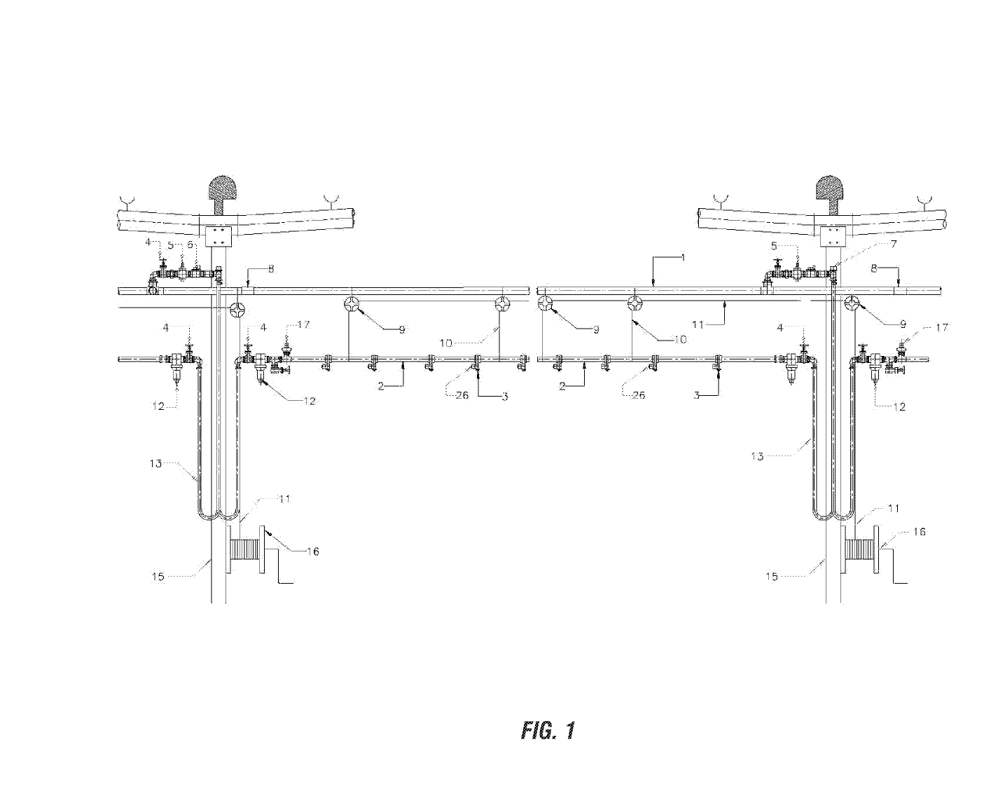

FIG. 2 shows the detailed automation device, comprising gate valve (4); pressure valve (5); solenoid valve (6); and retention valve (7).

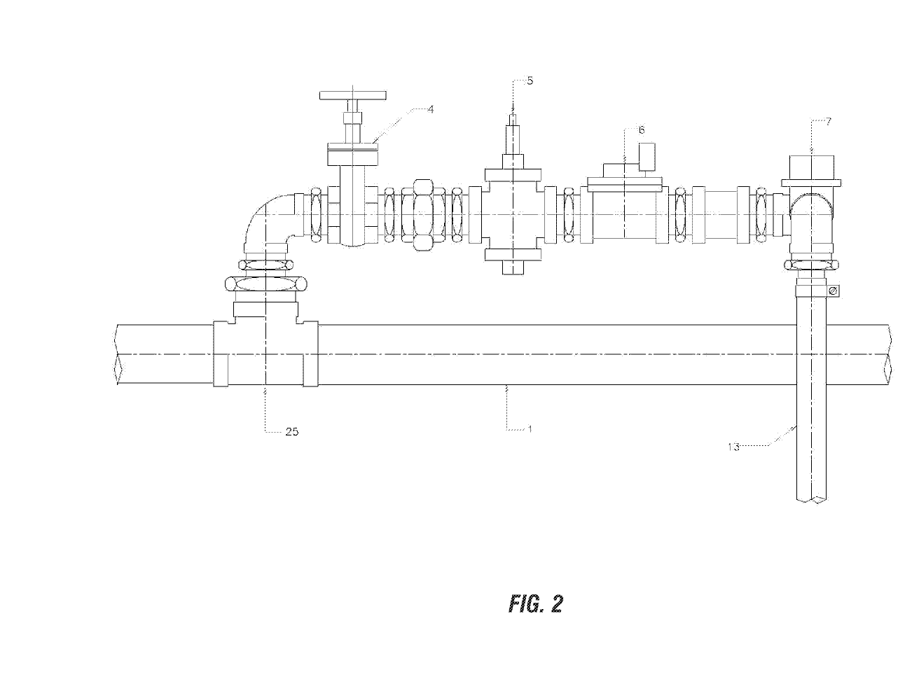

FIG. 3 shows the secondary tubing (2) of distribution, supported by steel cables like suspension strings (10) fixed to a steel cable master (11), passing by a reel (9) fixed in the main tubing (1) supported in the aerial structure of the central pivot; supporting towers of the segments (15) of the pivot ; reels (9); and winch turnpike (16) adjusts the height of the tubing (2) of distribution to the manual and/or motor-reducer system to the electric system and still at the entrance ending of the distribution tubing, there are gate valves (4), line filters (12) and sucker (17) for elimination of the air.

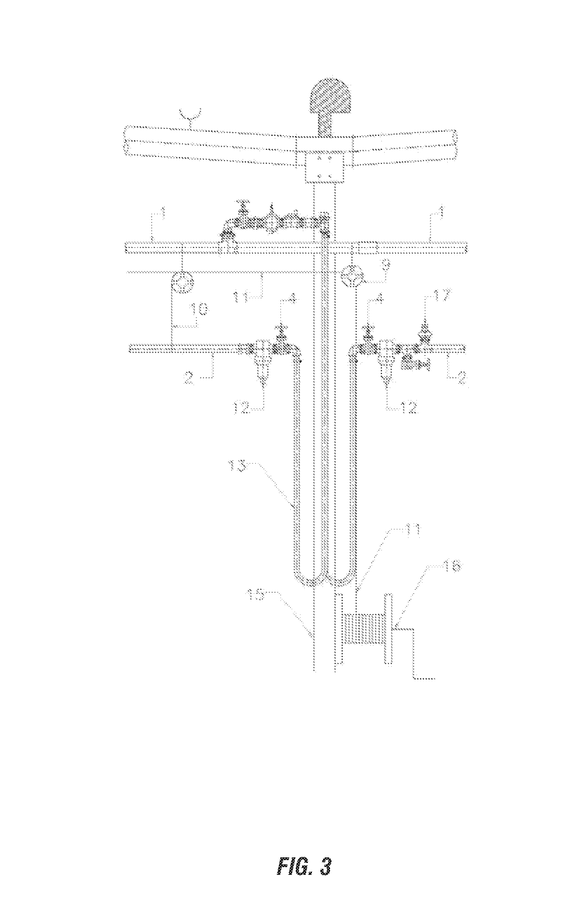

FIG. 4 shows the equipment supported by the aerial structure (14) of the central pivot, the main tubing (1); secondary tubing (2); steel cables like suspension strings (10); steel cables masters (11); support towers of the segments (15) of the pivot; towers and turnpike (winch) (16).

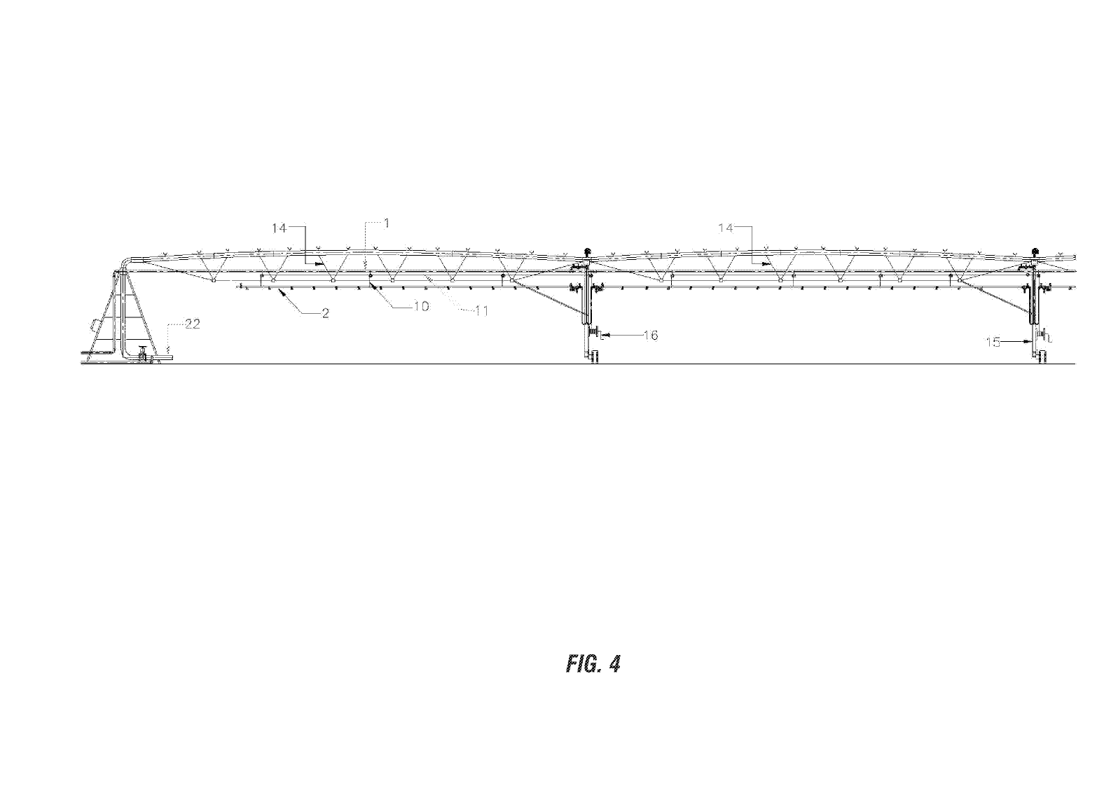

FIG. 5 shows the main motor-pump (18) installed with the tanks (19) of solution preparation in the center of central pivot responsible for making the pumping to the equipment, passing by a device with pressure valve (20) for control of the pressure excess, when the central pivot works in slope condition and still another device of central filtering, self-cleaning filters (21), while the reservoir tank (19) was supplied with water from the main pipeline (22) of the central pivot, through a tubing of small diameter (23).

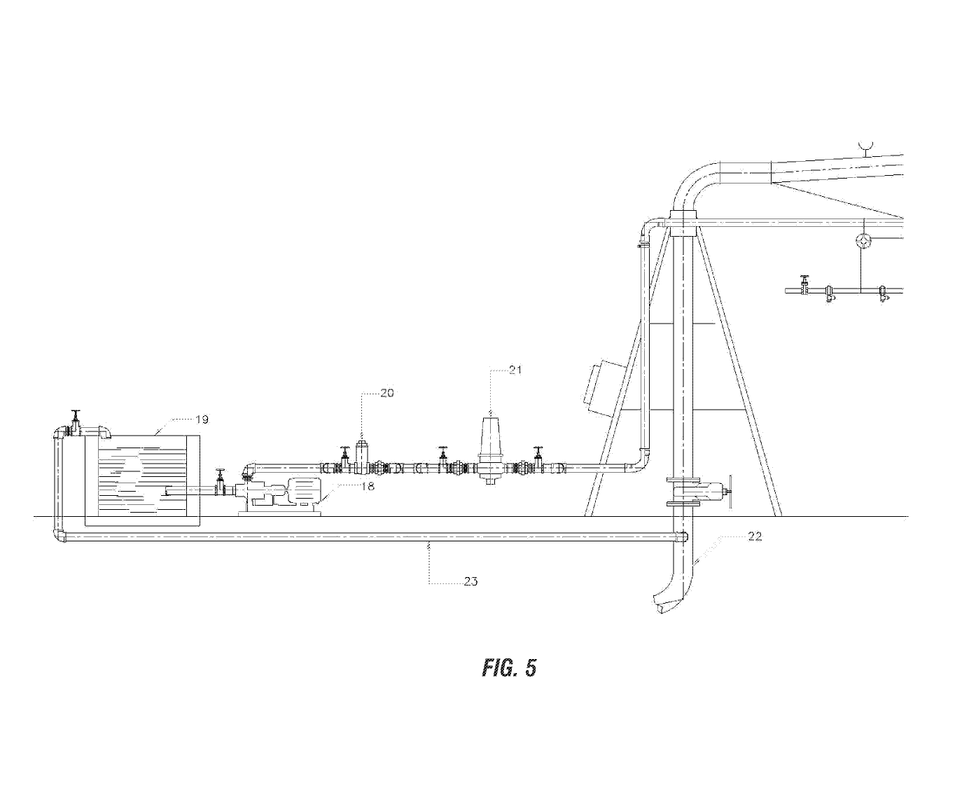

FIG. 6 shows the detailing of the main motor-pump (18) of the device of central pressure regulation with pressure valve (20) central filtering device, self- cleaning filters (21).

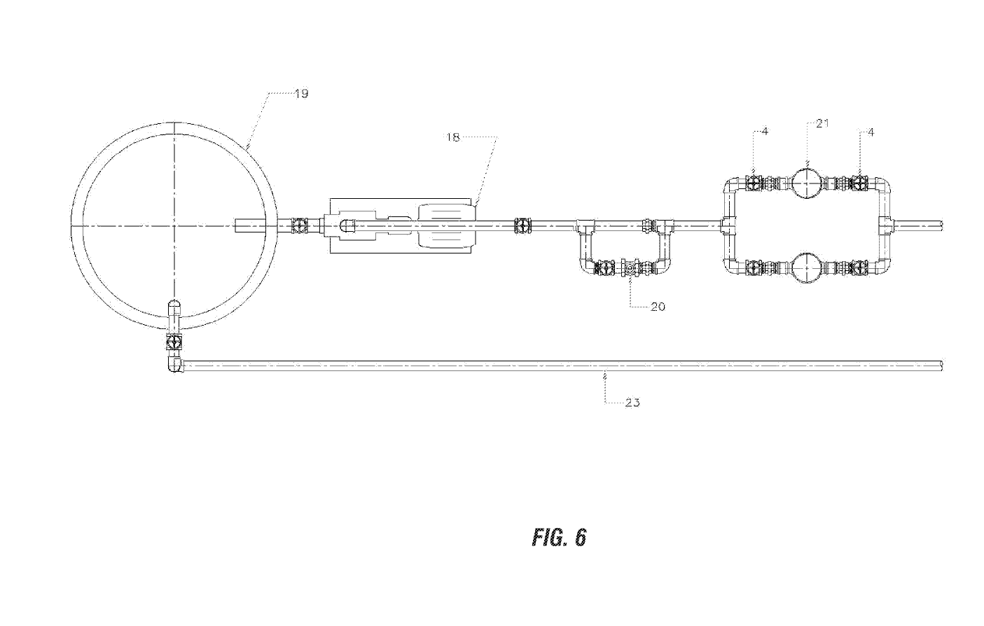

FIG. 7 shows the auxiliary motor-pump (24) installed with the water source (river or dam) that fueled the main pipeline (22) of pivot.

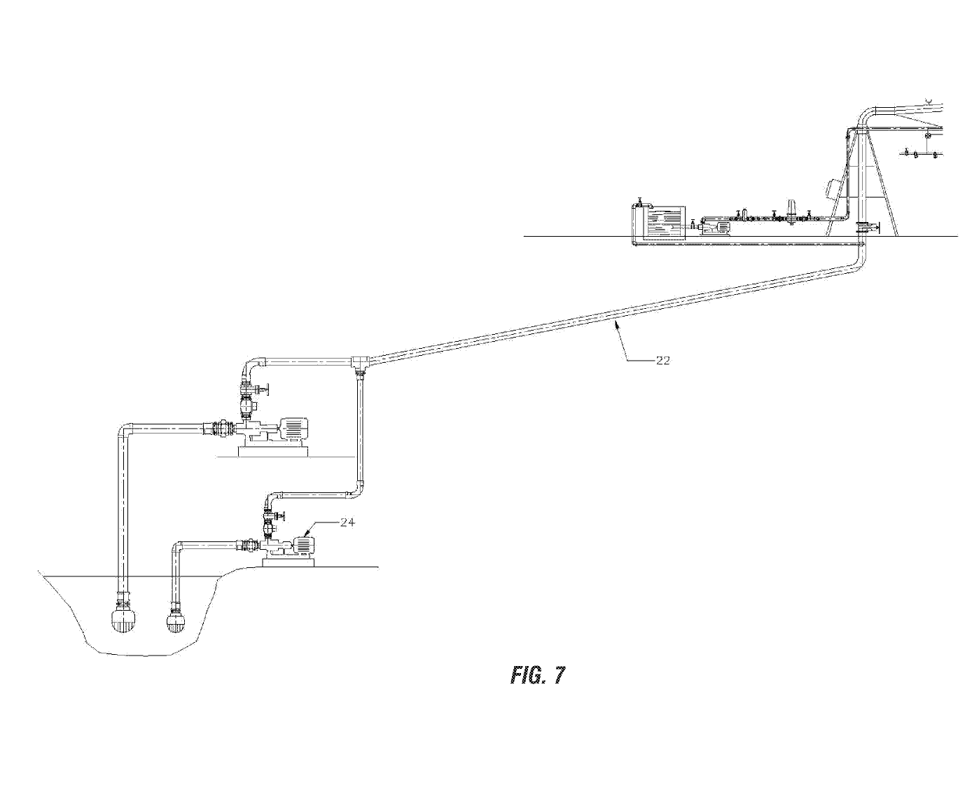

1) “Double tubing distributing of fertilizers and pesticides fixed to aerial structure of central pivot, thrown and controlled by automation devices consist of gate valves, pressure valves, solenoid valves and check valves”, wherein comprehends two tubing installed with the length of the central pivot, being the superior main tubing (1) supported and fixed by staples on aerial structure (14) of the central pivot, responsible by derivation of the solution through “T” (25) for the automation devices with the towers and still drives the solution to the ending of the pivot, and the secondary tubing (2) movable, of derivation, suspended by steel cables like suspension strings (10) with com “spray” nozzles (3) responsible for distribution and application of the fertilizers and pesticides.

2) “Double tubing distributing of fertilizers and pesticides fixed to aerial structure of central pivot, thrown and controlled by automation devices consist of gate valves, pressure valves, solenoid valves and check valves”, wherein comprehends a device of automation installed in the derivation of the main tubing (1) of the equipment with the motorized towers (15) of the central pivot, mounted with components of extreme importance for the functioning of the equipment formed by gate valves (4), pressure valves (5), solenoid valves (6) connected by electric cables to the contacting key or micro-switch from the electric box presented in the top of each motorized tower (15) of the central pivot, which has the function of liberating or interrupting the solution flow, when the towers were activated, or not, showing the synchronism in the sprays (3) opening during the self-pulsating pulverization and/or intermittent pulverization and two check valves (7) with exits connected by flexible hoses (13) to the distribution tubing (2), which avoid the interference of the solution flow between distribution tubing.

3) “Double tubing distributing of fertilizers and pesticides fixed to aerial structure of central pivot, thrown and controlled by automation devices consist of gate valves, pressure valves, solenoid valves and check valves”, which comprehends secondary tubing (2), movable, with sprays (3) fixed through steel cables like suspension strings (10) to a cable master (11), passing by reels (9) fixed in the main tubing (1) that adjusted the distance of the height until the crops through a winch turnpike (16) to the manual and/or motor-reducer system with remote control for the electric system. In the distribution tubing, sprays (3) were installed at pre-determined distances, with the diameter of nozzles equal or varying according to flow determined by the position of the pulverized ring area; anti-leaky valves (26) were also installed to interrupt the pulverization, keeping the tubing pressurized, when the solenoid valves (5) were off by electric contacting key and, in the endings of the secondary tubing, gate valves (4), line filters (12) and sucker valves (17) were installed.

4) “Double tubing distributing of fertilizers and pesticides fixed to aerial structure of central pivot, thrown and controlled by automation devices consist of gate valves, pressure valves, solenoid valves and check valves”, wherein comprehends a main motor-pump (18) installed with the reservoir tanks (19) of solution preparation in the center of central pivot, which makes the pumping to the equipment, passing by a device with pressure valve (20) for controlling of the pressure excess, when the central pivot works in slope condition, and still another device of central filtering, self-cleaning filters (21), being the reservoir tank supplied with water from the main pipeline (22) of the central pivot through a small tubing (23) with register , being the water pumped by another auxiliary motor-pump (24) installed with the water source (river or dam) which fueled the main pipeline (22) of pivot.
